(19) United States
(12) Patent Application Publication
(10) Pub. No.: US 2018/0165177 A1
(43) Pub. Date: Jun. 14, 2018

(54) DEBUGGING DISTRIBUTED WEB SERVICE REQUESTS

(71) Applicant: Nutanix, Inc., San Jose, CA (US)

(72) Inventors: Vinod GUPTA, Fremont, CA (US); Ranjan PARTHASARATHY, Milpitas, CA (US); Abhijit S. KHINVASARA, Los Altos, CA (US)

(73) Assignee: Nutanix, Inc., San Jose, CA (US)

(21) Appl. No.: 15/372,832

(22) Filed: Dec. 8, 2016

(51) Int. Cl. G06F 11/36

(52) U.S. Cl. CPC G06F 11/3664; G06F 11/3636; H04L 67/02; G06F 11/366; G06F 11/3648

(57) ABSTRACT

Systems and methods for debugging a web service request that is dispatched to one of a set of candidate processing environments. A method embodiment commences upon detecting a web service request that is dispatched from a dispatcher or load balancer to a target web service provider. Upon detection, one or more rules are applied over the web service request to determine if the particular request is intended to be intercepted and operated over in a debug session. If such rules fire, then a debug session is established at a remote debug system that has been preconfigured with debugging software and hardware suited for debugging using network traffic such as web service requests. A user operates the remote debug system for capturing debug information pertaining to the particulars of the web service transaction messages. The web service request is forwarded to the web service provider when the debug session is closed.

### FIELD

This disclosure relates to distributed computing system management, and more particularly to techniques for debugging distributed web service requests.

### BACKGROUND

Modern distributed computing systems comprise components that are combined to achieve efficient scaling of distributed computing resources, such as distributed data storage resources, distributed networking resources, and/or other resources. Such distributed computing systems have evolved in such a way that incremental linear scaling can be accomplished in many dimensions. The resources in a given distributed system are often grouped into resource subsystems such as clusters, data centers, and/or sites. The resource subsystems can be defined by physical and/or logical boundaries. For example, a cluster might comprise a logically bounded set of nodes associated with a certain department of an enterprise, while a data center might be associated with a particular physical geographical location.

Modern clusters in a distributed computing system might support over one hundred nodes (or more) that in turn support as many as several thousand (or more) autonomous virtualized entities (VEs) running various workloads. Such VEs might be virtual machines (VMs) and/or executable containers in hypervisor-assisted virtualization environments and/or in hypervisor-assisted operating system virtualization environments. The resources and/or consumers of the resources in a distributed computing system are often managed using various software services (e.g., web services, application services, etc.) implemented in the system.

The software services can perform tasks such as resource monitoring, resource analysis (e.g., performance, state, health, etc.), resource scheduling (e.g., VE and/or workload creation, modification, migration, deletion, etc.), and/or other tasks. In many cases, the software services are implemented as web services having respective service application programming interfaces (APIs) to facilitate communication with one another and/or with a centralized client (e.g., application, web application) to carry out the resource management tasks. For example, a user (e.g., system administrator) might interact with a centralized cluster management application (e.g., client) to monitor and/or schedule resources at the aforementioned cluster having one hundred or more nodes and several thousand or more VEs. In this case, the centralized application might dynamically dispatch various web service requests to instances of web servers across the cluster to carry out the monitoring and/or scheduling intent of the user. The web service requests might target a web service provider (e.g., via a URI) that is located outside of the cluster.

Unfortunately, debugging web services demands a particular set of debugging tools (e.g., software and hardware), and such tools might not be available on the web server that is the target of the dispatch. Worse, the web service request might be dynamically dispatched to a web server that is configured for purposes of load balancing or other processing, but not configured for debugging. In such cases, the web service requestor cannot know a priori and/or depend on whichever web server will be selected to process the web service request. This lack of a priori knowledge of the dispatched-to processing environment can present inefficiencies and/or other issues related to debugging problems with a particular dynamically dispatched web service request.

Legacy approaches have attempted to provide debugging capabilities by enabling a system-wide (e.g., cluster-wide) debug mode that includes a logging facility, however such system-wide approaches do not scale well. For example, collecting and analyzing historical debug log files from hundreds of nodes in a given cluster to discover the root cause (e.g., API call formatting, payload formatting, etc.) of a single failed request can consume significant time and computing, storage, and networking resources. Moreover, there is no guarantee the issue can be discovered and/or debugged using such techniques.

The deficiencies of such approaches are further amplified by the high frequency of occurrence and the short-lived nature of the web service requests. Specifically, in large, highly dynamic (e.g., scaling-out) distributed computing systems, the number of web service requests becomes more and more voluminous, which can further reduce the inefficiencies of the aforementioned system-wide debug approaches. Other approaches might reissue a failed request to a particular web server selected for debugging purposes. However, such approaches can be limited as to reproducing the earlier failure (or other issue) and/or identifying the root cause of the earlier failure, since the conditions of the debug environment are different as compared to the conditions pertaining to the earlier failure. What is needed is a technological solution for real-time, efficient debugging of web service requests that are dynamically dispatched to various processing environments in distributed computing systems.

What is needed is a technique or techniques to improve over legacy techniques and/or over other considered approaches. Some of the approaches described in this background section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY

The present disclosure provides a detailed description of techniques used in systems, methods, and in computer program products for debugging distributed web service requests, which techniques advance the relevant technologies to address technological issues with legacy approaches. More specifically, the present disclosure provides a detailed description of techniques used in systems, methods, and in computer program products for efficiently debugging dynamically distributed web service requests in distributed computing environments. Certain embodiments are directed to technological solutions that dynamically invoke a debug session at a predetermined computing environment to debug a web service request regardless of the target processing environment that was selected by a web service request dispatcher.

The disclosed embodiments modify and improve over legacy approaches. In particular, the herein-disclosed techniques provide technical solutions that address the technical problems attendant to efficiently debugging web service requests even when web service requests are dynamically dispatched to processing environments that are not known in advance by the web service requestor. Such technical solutions relate to improvements in computer functionality. Various applications of the herein-disclosed improvements in computer functionality serve to reduce the demand for computer memory, reduce the demand for computer processing power, reduce network bandwidth use, and reduce the demand for inter-component communication. Some embodiments disclosed herein use techniques to improve the functioning of multiple systems within the disclosed environments, and some embodiments advance peripheral technical fields as well. As one specific example, use of the disclosed techniques and devices within the shown environments as depicted in the figures provide advances in the technical field of debugging as well as advances in various technical fields related to specific fields pertaining to debugging in hyperconverged computing platform environments.

Further details of aspects, objectives, and advantages of the technological embodiments are described herein and in the drawings and claims.

### BRIEF DESCRIPTION OF THE DRAWINGS

The drawings described below are for illustration purposes only. The drawings are not intended to limit the scope of the present disclosure.

FIG. 1A1 and FIG. 1A2 present web service request debugging techniques as implemented in distributed computing systems, according to some embodiments.

FIG. 1B depicts a dynamic distributed service request debugging technique as implemented in systems for efficiently debugging dynamically distributed web service requests in distributed computing environments, according to an embodiment.

FIG. 2 presents an interaction diagram showing an inter-component protocol that facilitates dynamically debugging distributed web service requests in distributed computing environments, according to an embodiment.

FIG. 3 depicts a web service request detection technique as implemented in systems for efficiently debugging dynamically distributed web service requests in distributed computing environments, according to an embodiment.

FIG. 4 depicts a request debugging technique as implemented in systems for efficiently debugging dynamically distributed web service requests in distributed computing environments, according to an embodiment.

FIG. 5 illustrates a computing environment that supports various techniques as used in systems for efficiently debugging dynamically distributed web service requests in distributed computing environments, according to an embodiment.

FIG. 6 presents a schematic of a hyperconverged distributed computing environment that supports various techniques as used in systems for in which embodiments of the present disclosure can operate.

FIG. 7 depicts system components as arrangements of computing modules that are interconnected so as to implement certain of the herein-disclosed embodiments.

FIG. 8A and FIG. 8B depict virtualized controller architectures comprising collections of interconnected components suitable for implementing embodiments of the present disclosure and/or for use in the herein-described environments.

### DETAILED DESCRIPTION

Embodiments in accordance with the present disclosure address the problem of efficiently debugging web service requests even when web service requests are dynamically dispatched to processing environments that are not known by the web service requestor. Some embodiments are directed to approaches that dynamically invoke a debug session at a predetermined computing environment (e.g., a preconfigured laptop) to debug a web service request regardless of the target processing environment that might be selected by a web service request dispatcher. The accompanying figures and discussions herein present example environments, systems, methods, and computer program products for efficiently debugging dynamically distributed web service requests in distributed computing environments.

### Overview

Disclosed herein are techniques for implementing instances of a request debugger layer in multiple candidate processing environments, which request debugger layer serves to conditionally invoke debug sessions pertaining to web service requests that were dispatched by a dispatcher to various target processing environments. In certain embodiments, instances of a request debugger session are invoked at each candidate processing environment in a distributed computing system. For example, web service requests that are dispatched to a given target processing environment are detected by the local request debugger, which invokes a corresponding debug session at a preconfigured debugging environment. The debug session in the preconfigured computing environment facilitates debugging of the detected service request at a preconfigured debugging platform, even though the request is served at a target processing environment that is not configured for debugging. In some embodiments, a set of debug rules is accessed by instances of the request debugger layer to facilitate identification of service requests that are intended to trigger invocation of a respective debug session. In some embodiments, the debug session is closed upon completion of the operations associated with the request. In some embodiments, the debug sessions comprise a fine-grained web service transaction trace associated with the detected service request. In some embodiments, the request debugger is implemented as a layer in a web server stack. In some embodiments, the remote debug system supports multiple instances of debugging sessions. In some embodiments, the remote debug system is a laptop computer.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Example Embodiments

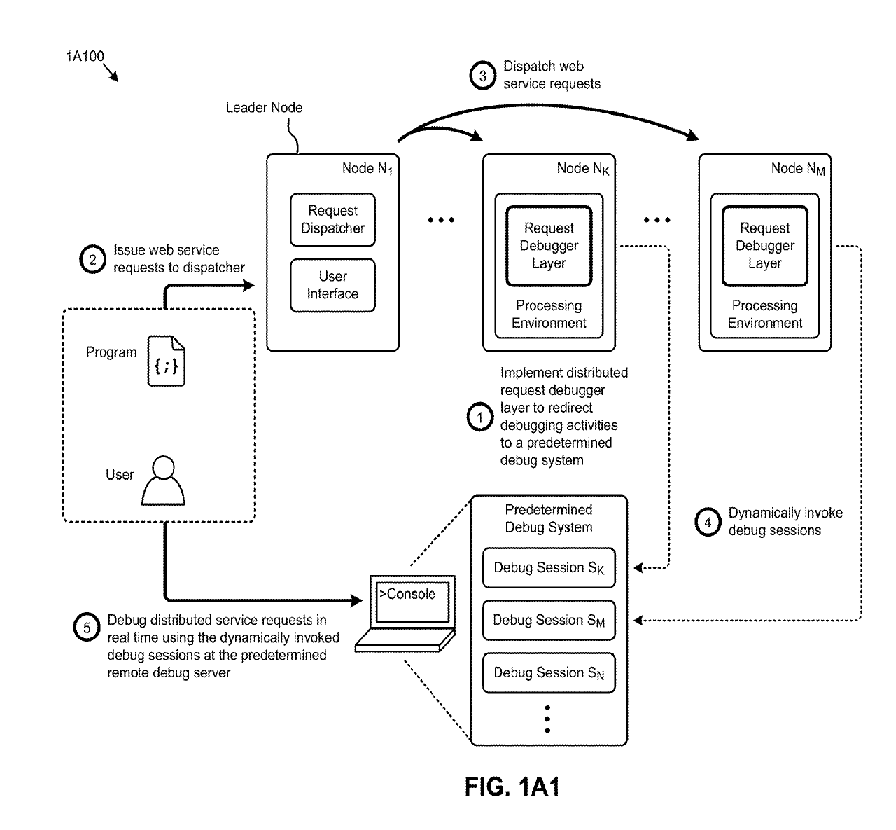

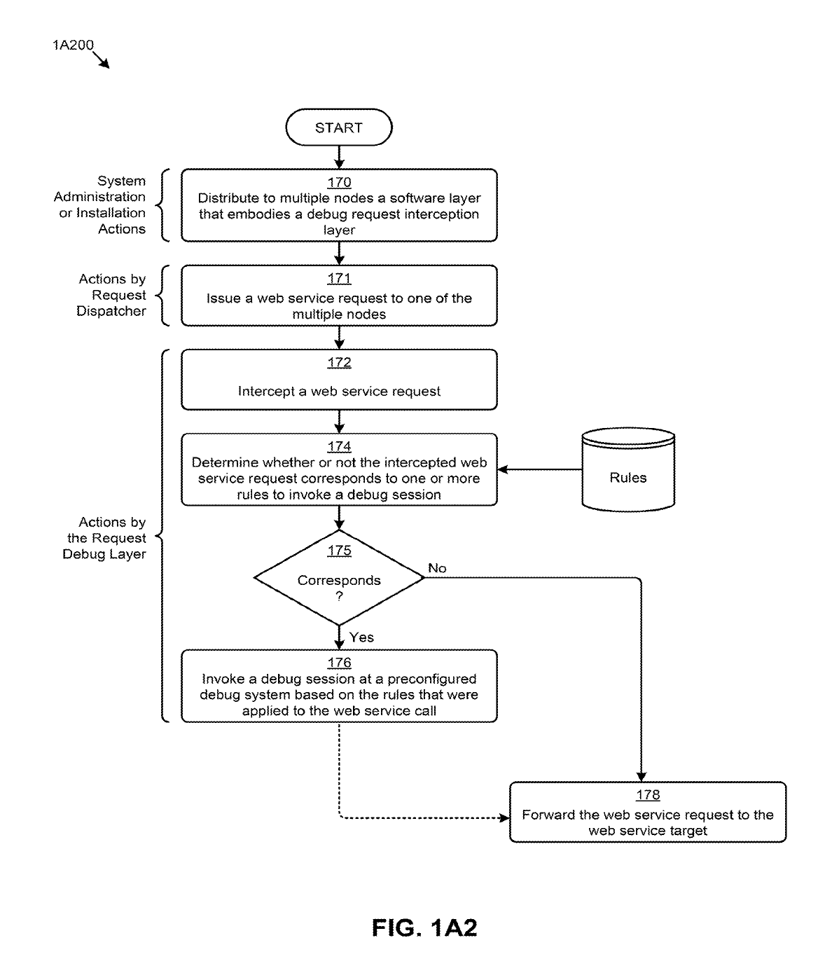

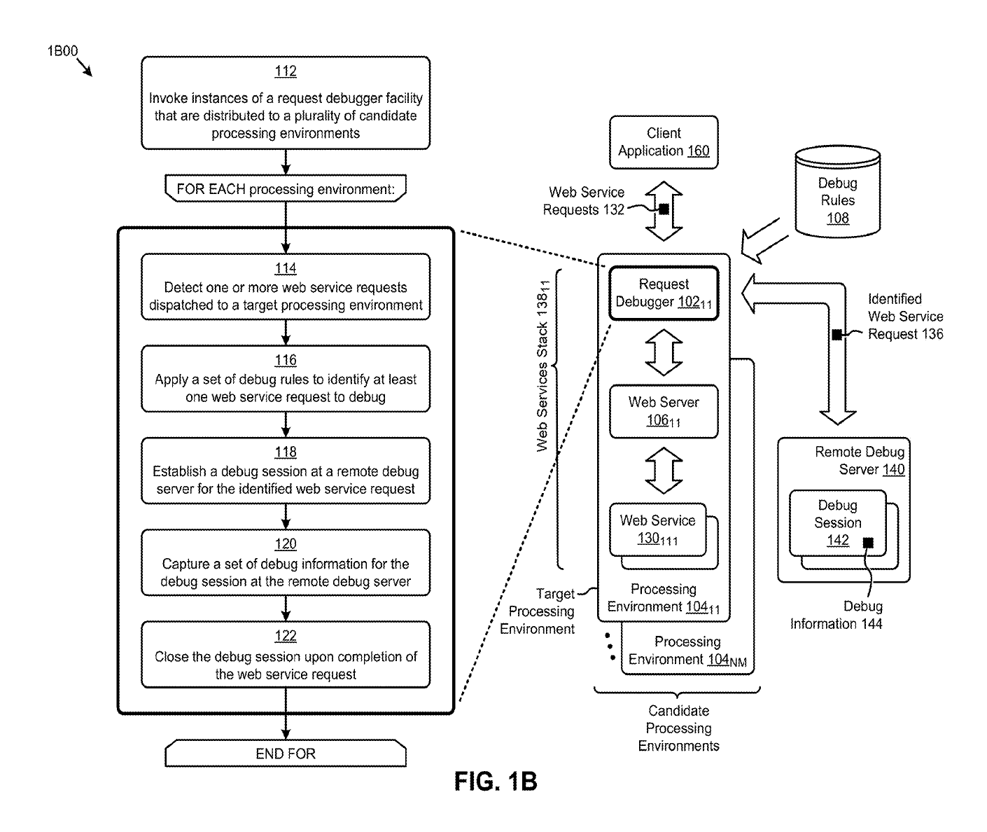

FIG. 1A1 presents a web service request debugging technique 1A100 as implemented in distributed computing systems. As an option, one or more variations of web service request debugging technique 1A100 or any aspect thereof may be implemented in the context of the architecture and functionality of the embodiments described herein. The web service request debugging technique 1A100 or any aspect thereof may be implemented in any environment.

The web service request debugging technique 1A100 presented in FIG. 1A1 illustrates one embodiment of techniques for implementing instances of a request debugger in multiple candidate processing environments to dynamically invoke debug sessions for debugging web service requests dispatched to one or more of the processing environments. Such techniques described herein address the problems attendant to efficiently debugging web service requests even when web service requests are dynamically dispatched to processing environments that are not known a priori by a web service requestor (e.g., user or machine). In many distributed computing environments, such web service requests are dispatched to a pool of web services in the processing environments to perform various resource management tasks. For example, a user (e.g., system administrator) might interact with a user interface of a centralized cluster management application (e.g., client application) at a leader node (e.g., node N₁) to monitor and/or schedule resources at a computing cluster comprising multiple nodes. In this case, the centralized application might dynamically dispatch various web service requests to selected processing environments across the cluster to carry out the monitoring and/or scheduling intent of the user.

As can be observed in the example embodiment of FIG. 1A1, the herein disclosed techniques can provide an efficient debug facility for such dynamically dispatched web service requests by implementing instances of a request debugger layer in the web services stack at each of the processing environments (operation 1). For example, a request debugger layer is implemented at each of the shown representative processing environments (e.g., at node N_{K} and node N_{M}). Web service requests issued by the system administrator are received by a request dispatcher (operation 2). The request dispatcher dynamically selects various target processing environments to receive and process the requests based on, for example, load balancing objectives (operation 3). The request debugger layer at each respective target processing environment intercepts the incoming web service requests and dynamically invokes debug sessions (e.g., debug session S_{K}, debug session S_{M}, debug session S_{N}, etc.) for certain web service requests (e.g., determined by a set of debug rules) at a preconfigured debugging system (operation 4). The debug session facilitates user interaction with a debugging console and other debugging interactions with the detected service request within a preconfigured debugging environment at a predetermined debug system, even though the request is served at a target processing environment that is not configured for debugging. The foregoing operations and/or other operations and/or techniques described herein facilitate debug of distributed service requests in real time using the dynamically invoked debug sessions at the predetermined debug system (operation 5).

A flowchart describing an embodiment of a dynamic distributed service request debugging technique is shown and described as pertaining to FIG. 1A2.

FIG. 1A2 presents a web service request debugging technique 1A200 as implemented in a distributed computing system. In the example shown, implementation of the technique commences when a system administrator or installation event causes a set of nodes in a multi-node computing environment to be configured with a debug request interception layer (step 170). Such nodes in the multi-node computing environment, more specifically, the debug request interception layers are armed so as to be able to intercept a web service request (at step 172) before it is processed by the targeted web service provider. More specifically, in some embodiments, an issued web service request (step 171) is processed by the aforementioned debug request interception layers so as to act as a proxy for the targeted web service provider, and thus can determine whether or not (at step 174) the issued web service request corresponds to a web service call that should be merely forwarded to the targeted web service provider, or should become the subject of a debug session.

In exemplary embodiments, rules are applied in making the aforementioned determination (of step 174). If the web service request corresponds to the firing of a rule, then the “Yes” branch of decision 175 is taken and a debug session is invoked (step 176) at a node (e.g., a laptop or other node that is preconfigured for debugging). If the “No” branch of decision 175 is taken (e.g., no rules fired) then the web service request is passed to the web service target (at step 178) without initiating or augmenting a debug session. In some cases, the interactions within a debug session result in forwarding the web service request to the intended web service target. Such forwarding might be performed after certain interactions within the debug session had changed a parameter or other aspect of the web service request. In other cases, even though a debug session was invoked, the web service request is passed to the web service target without modification of the web service request.

The shown rules used at step 174 can be modified by a user or administrator so as to create or modify rules that control invocation of one or more debug sessions (e.g., at a preconfigured workstation in the cluster, or at a preconfigured laptop, etc.) based on aspects of the web service request and/or based on computing environment characteristics that can be determined in real-time based on then current computing environment conditions.

The preconfigured debugging environment supports specific debugging capabilities that are particular to activities involved in debugging web service requests. In particular, debugging a web service request might involve use of a hardware and/or software “sniffer” that “listens” to protocol activity on a communication channel (e.g., an Ethernet channel), and/or, debugging a web service request might involve use of a hardware and/or software emulator and/or other specialized debugging tools. Moreover, use of such specialized debugging tools might be most effective when used on an intercepted web service request (e.g., before the web service request is fully dispatched to one of a set of candidate processing environments that serve as a target where the web service is hosted).

Further details describing an embodiment of a dynamic distributed service request debugging technique facilitated by instances of a request debugger implemented in a set of respective processing environments is shown and described as pertaining to FIG. 1B.

FIG. 1B depicts a dynamic distributed service request debugging technique 1B00 as implemented in systems for efficiently debugging dynamically distributed web service requests in distributed computing environments. As an option, one or more variations of dynamic distributed service request debugging technique 1B00 or any aspect thereof may be implemented in the context of the architecture and functionality of the embodiments described herein. The dynamic distributed service request debugging technique 1B00 or any aspect thereof may be implemented in any environment.

The embodiment shown in FIG. 1B is merely one example implementation of the herein disclosed techniques to dynamically invoke debug sessions at a remote debug system (e.g., remote debug server 140) for debugging web service requests distributed to various instances of web services. Such web services are systems of software that facilitate different machines to interact with each other through a network. Web services use various APIs, languages (e.g., XML, JSON, etc.), frameworks (e.g., Flask, Django, etc.), protocols (e.g., HTTP, SOAP, etc.), and/or other facilities to achieve this task. Web services are often implemented to achieve reusability of certain application components such as weather reports, currency converters, and/or other components. In some cases, web services are implemented in certain environments (e.g., distributed computing environments) to carry out tasks specific to the particular environment. For example, web services in a hyperconverged distributed computing system might be used to create a virtual machine, delete a virtual machine, create a storage volume (e.g., virtual disk), and/or perform other operations. A web service request comprises various data and/or instructions organized into a data structure for delivery to the web services. Since web services are often accessed over a network (e.g., the Internet, an intranet, etc.), web service requests are likewise often structured to conform to a network communication protocol and/or to a web server. For example, a given web service request might be communicated in HTTP for processing at a web server built on the Web Server Gateway Interface (WSGI) standard. Responses and/or other transaction messages associated with the web services will often conform to the structures and/or protocols of the web service requests.

As can be observed, the embodiment in FIG. 1B shows request debugger 102₁₁ implemented as a layer in web services stack 138₁₁ associated with processing environment 104₁₁ to carry out certain steps and/or operations comprising the dynamic distributed service request debugging technique 1B00. Specifically, request debugger 102₁₁ is implemented in web services stack 138₁₁ on top of web server 106₁₁ and the set of web services (e.g., web service 130₁₁₁) accessible from processing environment 104₁₁. The request debugger, web server, and web services can be instantiated in any or all of the other processing environments (e.g., processing environment 104_{NM}) in a given distributed computing environment. The set of processing environments available to serve a given web service request are referred to herein as candidate processing environments. Further, the set of web services available to process such web service requests can be referred to a process pool.

As shown in the steps and/or operations of the dynamic distributed service request debugging technique 1B00, the instances of the request debugger at the candidate processing environments are invoked to facilitate debugging web service requests distributed to the candidate processing environments (step 112). Specifically, at each processing environment, the request debugger detects one or more web service requests dispatched to that particular target processing environment (step 114). For example, request debugger 102₁₁ will detect a set of web service requests 132 from client application 160 that are dispatched to processing environment 104₁₁. In this case, processing environment 104₁₁ is selected (e.g., by a request dispatcher, load balancing layer, etc.) as the target processing environment for web service requests 132. A set of debug rules are applied to the detected web service requests to identify any web service requests that are to be debugged (step 116). As an example, a set of debug rules 108, accessible to all instances of the request debugger, can be applied by request debugger 102₁₁ to web service requests 132 to identify a particular web service request (e.g., identified web service request 136) to be debugged.

Request debugger 102₁₁ then establishes debug session 142 for the identified web service request 136 at remote debug server 140 (step 118). As illustrated, remote debug server 140 can host multiple debug sessions established by various instances of the request debugger in the system. Debug information (e.g., debug information 144) pertaining to the identified web service request 136 is captured at remote debug server 140 (step 120). For example, the identified web service request 136 (and other web service requests dispatched to processing environment 104₁₁) are passed through to web server 106₁₁ for processing, and debug information 144 is captured during such processing. When processing of the identified web service request 136 is complete, the debug session is closed (step 122).

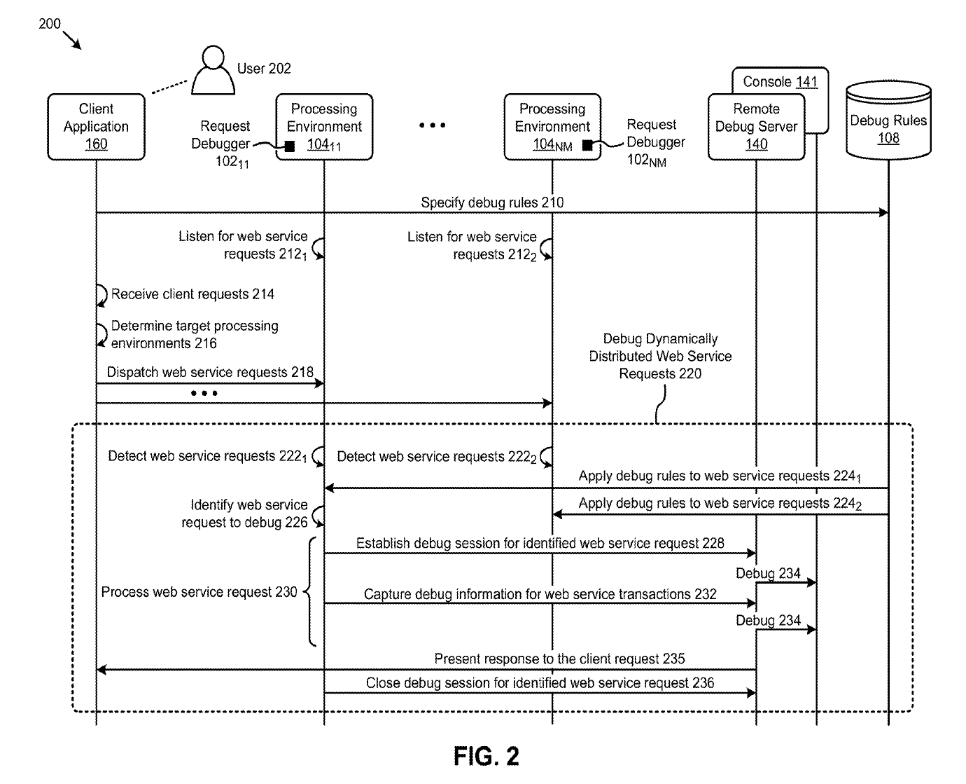

Further details characterizing the interactions between some of the components shown in FIG. 1B are shown and described as pertaining to FIG. 2.

FIG. 2 presents an interaction diagram 200 showing an inter-component protocol that facilitates dynamically debugging distributed web service requests in distributed computing environments. As an option, one or more variations of interaction diagram 200 or any aspect thereof may be implemented in the context of the architecture and functionality of the embodiments described herein. The interaction diagram 200 or any aspect thereof may be implemented in any environment.

Interaction diagram 200 presents various components and/or entities earlier described as pertaining to FIG. 1B exhibiting a set of high order interactions (e.g., operations, messages, etc.) to facilitate implementations of the herein disclosed techniques. Specifically shown are client application 160, a set of representative candidate processing environments (e.g., processing environment 104₁₁ and processing environment 104_{NM}), remote debug server 140, and debug rules 108). Instances of the request debugger (e.g., request debugger 102₁₁, request debugger 102_{NM}) are also shown in respective instances of the candidate processing environments.

As depicted in the interaction diagram 200, user 202 can interact with client application 160 to specify one or all of debug rules 108 (message 210). For example, user 202 might specify the request type, environment location, and/or other attributes of the set of web service requests that the user desires to debug. The request debuggers instantiated at each processing environment are invoked to listen for web service requests dispatched to their respective environment (operation 212₁, operation 212₂). Client requests are received at client application 160 (operation 214) and target processing environments for each request are determined (operation 216). For example, client requests might correspond to certain resource configuration changes (e.g., VE migration, workload reallocation, etc.) desired by user 202 and/or determined by the underlying system. Also, as earlier mentioned, the target processing environments can be determined based on various objectives, such as objectives pertaining to balancing the usage of resources (e.g., compute, storage, networking, etc.) across a given distributed computing system. In this case, the target processing environments are dynamically determined at the moment in time corresponding to receipt of the client request. When the target processing environments are determined, the web service requests are dispatched to their respective target processing environments (step 218). FIG. 2 depicts at least some of the web service requests being dispatched to each of the representative processing environments.

As illustrated in interaction diagram 200, a group of interactions can facilitate debug of the aforementioned dynamically distributed web service requests (see grouping 220). Specifically, the instances of the request debugger at each processing environment detects the web service requests dispatched to their respective environment (operation 222₁ and operation 222₂). Debug rules 108 are accessed and applied to the detected web service requests to identify any web service requests to be debugged (message 224₁, message 224₂). In some cases, applying debug rules 108 will result in identifying a web service request or set of web service requests for debug (operation 226). For example, applying the attributes of a particular detected web service request and/or other conditions (e.g., the target processing environment) as inputs to one or more of the debug rules 108 might result in a “true” debug flag. In other cases, the detected web service requests received at a given processing environment might not result in a debug indication. For example, no web service requests are identified for debug at processing environment 104_{NM}.

For the web service request identified for debug at processing environment 104₁₁, a debug session is established at remote debug server 140 (message 228). As the web service is processed at processing environment 104₁₁ (operation 230), debugging operations are being performed (e.g., code step-through) and debug information pertaining to web service transactions are captured (messages 234) at the remote debug server (message 232) and/or at console 141 (messages 234). For example, the captured debug information might comprise a line-by-line transaction stack trace. In some embodiments, the debug information is presented to console 141 to be viewed by a user. In other embodiments, some or all of the debug information might be stored in a log file. When the identified web service request processing is sufficiently complete so as to produce at least a portion of the response pertaining to the request, then the response or portion thereof can be presented to client application 160 (message 235). To complete this portion of the shown protocol, the debug session at the remote debug server is closed (message 236) and debug resources can be freed for reuse.

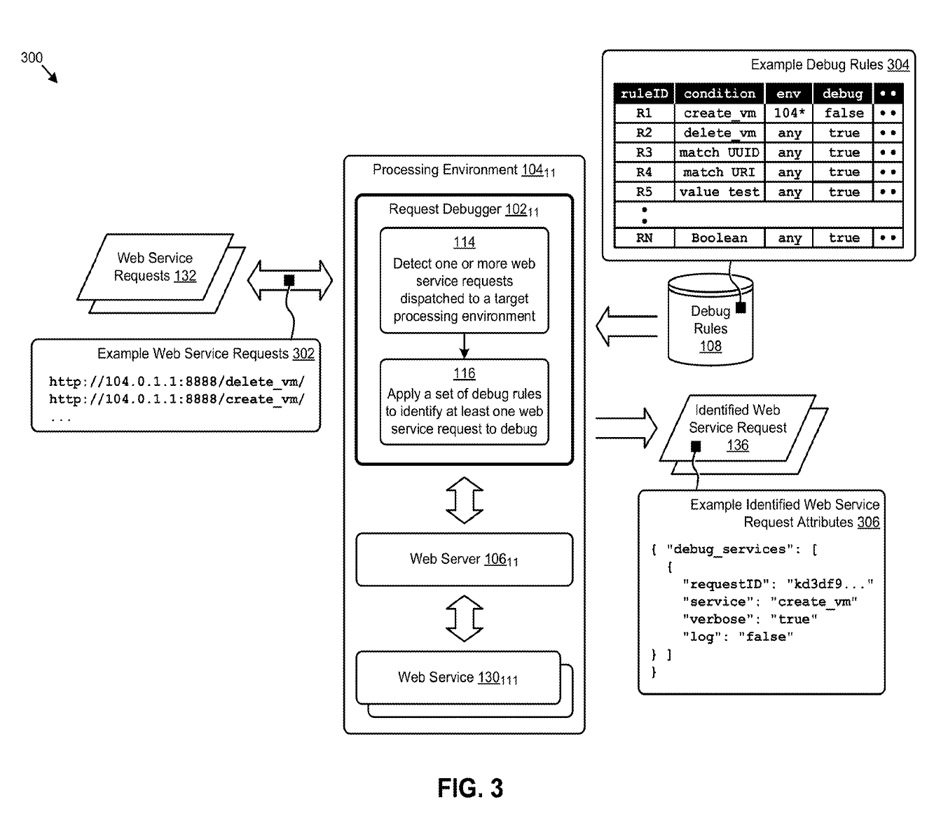

Additional details related to detecting web service requests at a given processing environment and identifying requests for debug are shown and described as pertaining to FIG. 3.

FIG. 3 depicts a web service request detection technique 300 as implemented in systems for efficiently debugging dynamically distributed web service requests in distributed computing environments. As an option, one or more variations of web service request detection technique 300 or any aspect thereof may be implemented in the context of the architecture and functionality of the embodiments described herein. The web service request detection technique 300 or any aspect thereof may be implemented in any environment.

Shown in FIG. 3 is one embodiment of various steps and/or operations performed by an instance of a request debugger to detect and identify web service requests to debug according to the herein disclosed techniques. Certain specialized data structures that are designed to improve the way a computer stores and retrieves data in memory when performing such steps and/or operations are also shown. The shown embodiment depicts processing environment 104₁₁ as a representative processing environment having a web services stack comprising a request debugger 102₁₁, a web server 106₁₁, and a set of web services (e.g., web service 130₁₁₁). As can be observed, a set of web service requests 132 dispatched to processing environment 104₁₁ are detected by request debugger 102₁₁ (step 114). For example, web server 106₁₁ might be instantiated on port “8888” in a processing environment (e.g., node) having an IP address of “104.0.1.1”. In this case, as depicted in example web service requests 302, the web service requests can be dispatched to processing environment 104₁₁ using the URL “http://104.0.1.1:8888”. Additionally, the web services can be accessed by web server 106₁₁ by exposing service API callable objects associated with the web services. Such service API callable objects might comprise, for example, a callable name (e.g., “create_vm”, “delete_vm”, etc.), a set of arguments (e.g., “environ” argument, “start_response” argument, etc.), and/or other object attributes. As an example, the web service request “http://104.0.1.1:8888/create_vm/” from example web service requests 302 received at the web server 106₁₁ can generate a call to a “create_vm” web service using the service API callable object.

The request debugger 102₁₁ applies debug rules 108 to such detected web service requests (step 116). A rule base, such as debug rules 108, comprise data records storing various information that can be used to form one or more constraints to apply to certain functions and/or operations. For example, a debug rule might provide a set of criteria (e.g., web service request attributes) that, if matched by a subject web service request, indicate the subject web service request is to be debugged. As another example, the information pertaining to a debug rule might comprise the conditional logic operators (e.g., “if”, “then”, “and”, “or”, “greater than”, “less than”, etc.) and/or operand references for forming a conditional logic statement that can be applied to various sets of operands.

The debug rules 108 are often organized and/or stored in a tabular structure (e.g., relational database table) having rows corresponding to a debug rule and columns corresponding to various attributes pertaining to that rule. For example, as depicted in example debug rules 304, a table row might describe a performance rule identifier or “ruleID”, a “condition” criteria for the rule, an environment criteria or “env” for the rule, a conditional “debug” indicator (e.g., “true” or “false”) such that if the foregoing criteria are met, the rule fires. Specifically, a rule “R1” might specify a “create_vm” service call in any environment with an IP address starting with “104” is to be debugged. As another example, a rule “R2” might specify a “delete_vm” service call in “any” environment should not be debugged. Other debug rules are possible.

Strictly as examples, a debug rule might fire when there is a match on the UUID of the calling session (e.g., the session that issued the web service request), or a debug rule might fire when there is a match on the URI of the web service request, or a debug rule might fire when a parameter or value given in the web service request matches a test value, or, for example a debug rule might fire when a Boolean expression evaluates to a particular value, etc. The rules can be modified by a user or administrator so as to create or modify rules that, when fired, control invocation of one or more debug sessions (e.g., via invocation parameters or via remote procedure calls, etc.) based on any Boolean expression of any literals and/or derived aspects of the web service request and/or based on computing environment characteristics (e.g., “UUID=V1” AND “NodeID=N1”, etc.) that can be determined in real-time based on then current computing environmental conditions.

Debug rules 108 can also be organized and/or stored in key-value pairs, where the key is the performance rule attribute or element of the attribute, and the value is the data element (e.g., number, character string, array, etc.) associated with the attribute or attribute element. In some cases, the key-value pairs can be used to store and/or communicate debug rules 108 in a structured object form (e.g., JSON, XML, etc.).

Applying debug rules 108 to web service requests 132 at request debugger 102₁₁ can identify one or more of the web service requests that are to be debugged. Such identified web service requests (e.g., identified web service request 136) can be characterized as shown in example identified web service request attributes 306. Specifically, example identified web service request attributes 306 indicates the “requestID” (e.g., “kd3df9 . . . ”) of identified web service request. The “create_vm” callable is also specified. The example identified web service request attributes 306 further depicts representative attributes pertaining to each identified web service request and associated debug facility, such as a debug information capture verbosity switch or “verbose” switch (e.g., “true” or “false”), and a debug “log” file switch (e.g., “true” or “false”). As shown, the key-value pairs describing the identified web service request attributes can be organized to store and/or communicate the attributes in a structured object form (e.g., JSON, XML, etc.).

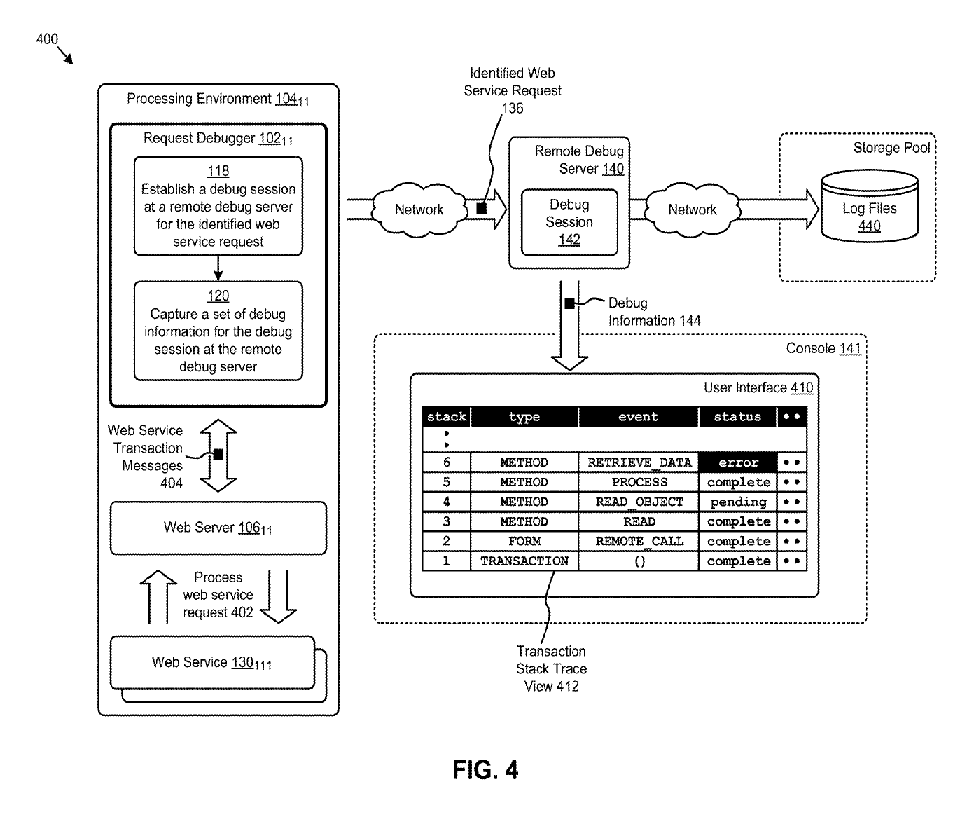

Specifically, such identified web service request attributes can be transmitted to a remote debug server to facilitate debugging of the identified web service request according to the herein disclosed techniques. One embodiment of a web service request debugging technique is shown and described as pertaining to FIG. 4.

FIG. 4 depicts a request debugging technique 400 as implemented in systems for efficiently debugging dynamically distributed web service requests in distributed computing environments. As an option, one or more variations of request debugging technique 400 or any aspect thereof may be implemented in the context of the architecture and functionality of the embodiments described herein. The request debugging technique 400 or any aspect thereof may be implemented in any environment.

Shown in FIG. 4 is one embodiment of various steps and/or operations performed by an instance of a request debugger to dynamically debug web service requests according to the herein disclosed techniques. Certain specialized data structures that are designed to improve the way a computer stores and retrieves data in memory when performing such steps and/or operations are also shown. The shown embodiment depicts processing environment 104₁₁ as a representative processing environment having a web services stack comprising request debugger 102₁₁, web server 106₁₁, and a set of web services (e.g., web service 130₁₁₁). As can be observed, a debug session is established via a remote web server for a web service request identified for debug (step 118). For example, information (e.g., attributes) pertaining to an identified web service request 136 might be delivered to remote debug server 140 to establish debug session 142. In some embodiments, identified web service request 136 can be identified by the techniques shown and described as pertaining to FIG. 3. A debug server is herein considered “remote” when the resources comprising the debug server are outside the physical and/or logical boundary of the target processing environment selected to serve the identified web service request. In some cases, the remote debug server may be implemented in a predetermined environment outside the boundaries of all candidate processing environments.

The identified web service request is passed through to web server 106₁₁, which interacts with (e.g., calls) one or more web services to serve the request (operation 402). A set of debug information 144 characterizing the activities (e.g., operations, transactions, etc.) associated with serving (e.g., processing) the identified web service request are captured at remote debug server 140 (step 120). For example, request debugger 102₁₁ might facilitate the capture of debug information at the remote debug server by collecting data associated with a set of web service transaction messages 404 communicated between web server 106₁₁ and web services 130₁₁₁. The detailed web service transaction data can facilitate construction of a “line-by-line” transaction stack trace for debugging the identified web service request.

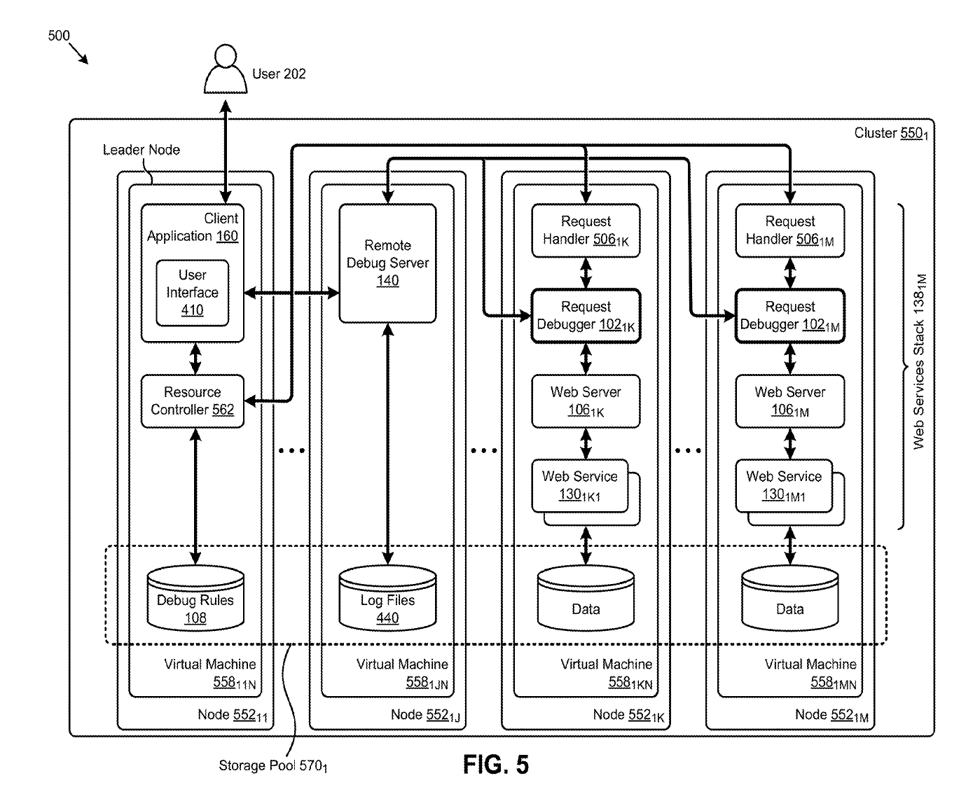

In some embodiments, such fine-grained debug information can be presented in a user interface. As an example, a transaction stack trace view 412 might be presented in a user interface 410, possibly within the shown console 141. As can be observed, the transaction stack trace can be displayed in a tabular structure having rows corresponding to respective transactions and columns corresponding to various attributes pertaining to that transaction. For example, as depicted in the transaction stack trace view 412, a table row might describe a transaction identifier or “stack” position, a transaction “type”, a transaction “event”, a transaction “status”, and/or other transaction attributes. Specifically, an “error” may have occurred for the “METHOD” transaction in position “6” in the stack. In some embodiments, debug information 144 captured at remote debug server 140 and/or other information (e.g., environment attributes, etc.) are recorded in a set of log files 440 that is accessed possibly over a network, and/or stored in a storage pool (see FIG. 5).

One embodiment of a subsystem and corresponding data flows for implementing any of the herein disclosed techniques is shown and described as pertaining to FIG. 5.

FIG. 5 illustrates a computing environment 500 that supports various techniques as used in systems for efficiently debugging dynamically distributed web service requests in distributed computing environments. As an option, one or more variations of computing environment 500 or any aspect thereof may be implemented in the context of the architecture and functionality of the embodiments described herein. The computing environment 500 or any aspect thereof may be implemented in any environment.

The computing environment 500 shown in FIG. 5 is merely one example of components and data flows implemented in a cluster (e.g., cluster 550₁) of a distributed computing system to support any of the herein disclosed techniques. As can be observed, cluster 550₁ comprises multiple nodes (e.g., node 552₁₁, node 552_{1J}, node 552_{1K}, node 552_{1M}, etc.) that in turn support multiple autonomous virtualized entities (e.g., virtual machines, containers, etc.) such as virtual machine 558_{11N}, virtual machine 558_{1JN}, virtual machine 558_{1KN}, and virtual machine 558_{1MN}. In the shown embodiment, the client application 160 is implemented at virtual machine 558_{11N} and comprises user interface 410 to facilitate interaction with the application by user 202. As an example, node 552₁₁ might be elected as a leader node in the cluster 550₁ that hosts a centralized access point (e.g., client application 160) to provide a cluster resource management facility for user 202 (e.g., a system administrator). In this case, for example, user 202 can interact with client application 160 to establish one or more of the debug rules 108. As shown, the debug rules 108 can be physically stored at node 552₁₁ but logically stored in a storage pool 570₁ such that they are accessible by any resource (e.g., node) in the cluster. In some embodiments, the leader node can further comprise a resource controller 562 to, among other functions, dispatch any web service requests originating from client application 160 to various target processing environments across cluster 550₁.

The processing environments in computing environment 500 comprise instances of web services stacks (e.g., web services stack 138_{1M}) implemented at multiple virtual machines and a respective set of nodes in the cluster. Specifically, a web services stack comprising request handler 506_{1K}, request debugger 102_{1K}, web server 106_{1K}, and a set of web services (e.g., web service 130_{1K1}) is implemented at virtual machine 558_{1KN} in node 552_{1K}. Further, a web services stack comprising request handler 506_{1M}, a request debugger 102_{1M}, web server 106_{1M}, and a set of web services (e.g., web service 130_{1M1}) is implemented at virtual machine 558_{1MN} in node 552_{1M}. The foregoing web services accessible by resources in cluster 550₁ can be included in a process pool, which in turn can be operated over by any embodiments of one or more web service request dispatchers. The web service requests dispatched from resource controller 562 are received at the respective request handler at each target processing environment for processing and/or debugging according to the herein disclosed techniques. For example, any web service requests identified for debugging (e.g., by applying debug rules 108 to the web service requests at the request debuggers) will dynamically invoke a respective debug session at the remote debug server 140. As shown, the remote debug server 140 can be implemented in a virtual machine (e.g., virtual machine 558_{1JN}) at a node (e.g., node 552_{1J}) in cluster 550₁. In some cases, the remote debug server might be implemented outside the cluster comprising the target processing environments (e.g., in a cloud environment). As shown, the log files 440 record debug information at the remote debug server 140 can be stored in storage pool 570₁. Further, the client application 160 can interact with the remote debug server 140 to facilitate user interaction with the debug sessions.

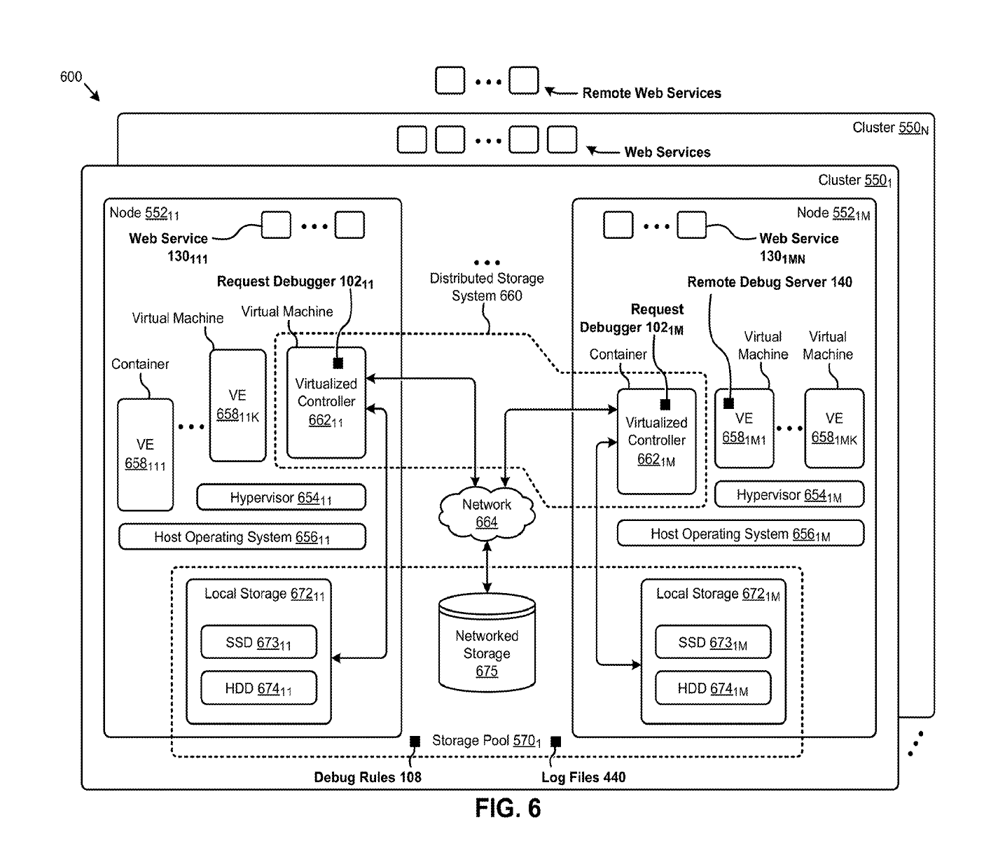

The components and data flows shown in FIG. 5 present merely one partitioning and associated data manipulation approach. The specific example shown is purely exemplary, and other subsystems and/or partitioning are reasonable. An example of a hyperconverged distributed computing environment that supports such components, data flows, and/or partitionings according to the herein disclosed techniques are presented and discussed as pertains to FIG. 6.

FIG. 6 presents a schematic of a hyperconverged distributed computing environment 600 that supports various techniques as used in systems for in which embodiments of the present disclosure can operate. As an option, one or more variations of hyperconverged distributed computing environment 600 or any aspect thereof may be implemented in the context of the architecture and functionality of the embodiments described herein. The hyperconverged distributed computing environment 600 or any aspect thereof may be implemented in any environment.

The shown distributed computing environment depicts various components associated with one instance of a hyperconverged distributed computing system (e.g., distributed virtualization system) comprising a distributed storage system 660 that can be used to implement the herein disclosed techniques. Specifically, the hyperconverged distributed computing environment 600 comprises multiple clusters (e.g., cluster 550₁, . . . , cluster 550_{N}) comprising multiple nodes that have multiple tiers of storage in a storage pool. Representative nodes (e.g., node 552₁₁, . . . , node 552_{1M}) and storage pool 570₁ associated with cluster 550₁ are shown. Each node can be associated with one server, multiple servers, or portions of a server. The nodes can be associated (e.g., logically and/or physically) with the clusters. As shown, the multiple tiers of storage include storage that is accessible through a network 664, such as a networked storage 675 (e.g., a storage area network or SAN, network attached storage or NAS, etc.). The multiple tiers of storage further include instances of local storage (e.g., local storage 672₁₁, . . . , local storage 672_{1M}). For example, the local storage can be within or directly attached to a server and/or appliance associated with the nodes. Such local storage can include solid state drives (SSD 673₁₁, . . . , SSD 673_{1M}), hard disk drives (HDD 674₁₁, . . . , HDD 674_{1M}), and/or other storage devices.

As shown, the nodes in hyperconverged distributed computing environment 600 can implement one or more user virtualized entities (e.g., VE 658₁₁₁, . . . , VE 658_{11K}, . . . , VE 658_{1M1}, VE 658_{1MK}), such as virtual machines (VMs) and/or containers. The VMs can be characterized as software-based computing “machines” implemented in a hypervisor-assisted virtualization environment that emulates the underlying hardware resources (e.g., CPU, memory, etc.) of the nodes. For example, multiple VMs can operate on one physical machine (e.g., node host computer) running a single host operating system (e.g., host operating system 656₁₁, . . . , host operating system 656_{1M}), while the VMs run multiple applications on various respective guest operating systems. Such flexibility can be facilitated at least in part by a hypervisor (e.g., hypervisor 654₁₁, . . . , hypervisor 654_{1M}), which hypervisor is logically located between the various guest operating systems of the VMs and the host operating system of the physical infrastructure (e.g., node).

As an example, hypervisors can be implemented using virtualization software (e.g., VMware ESXi, Microsoft Hyper-V, RedHat KVM, Nutanix AHV, etc.) that includes a hypervisor. In comparison, the containers (e.g., application containers or ACs) are implemented at the nodes in an operating system virtualization environment or container virtualization environment. The containers comprise groups of processes and/or resources (e.g., memory, CPU, disk, etc.) that are isolated from the node host computer and other containers. Such containers directly interface with the kernel of the host operating system (e.g., host operating system 656₁₁, . . . , host operating system 656_{1M}) without, in most cases, a hypervisor layer. This lightweight implementation can facilitate efficient distribution of certain software components, such as applications or services (e.g., micro-services). As shown, hyperconverged distributed computing environment 600 can implement both a hypervisor-assisted virtualization environment and a container virtualization environment for various purposes.

Hyperconverged distributed computing environment 600 also comprises at least one instance of a virtualized controller to facilitate access to storage pool 570₁ by the VMs and/or containers.

As used in these embodiments, a virtualized controller is a collection of software instructions that serve to abstract details of underlying hardware or software components from one or more higher-level processing entities. A virtualized controller can be implemented as a virtual machine, as a container (e.g., a Docker container), or within a layer (e.g., such as a hypervisor).

Multiple instances of such virtualized controllers can coordinate within a cluster to form the distributed storage system 660 which can, among other operations, manage the storage pool 570₁. This architecture further facilitates efficient scaling of the distributed virtualization system. The foregoing virtualized controllers can be implemented in hyperconverged distributed computing environment 600 using various techniques. Specifically, an instance of a virtual machine at a given node can be used as a virtualized controller in a hypervisor-assisted virtualization environment to manage storage and I/O (input/output or IO) activities. In this case, for example, the virtualize entities at node 552₁₁ can interface with a controller virtual machine (e.g., virtualized controller 662₁₁) through hypervisor 654₁₁ to access the storage pool 570₁. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 660.

For example, a hypervisor at one node in the distributed storage system 660 might correspond to VMware ESXi software, and a hypervisor at another node in the distributed storage system 660 might correspond to Nutanix AHV software. As another virtualized controller implementation example, containers (e.g., Docker containers) can be used to implement a virtualized controller (e.g., virtualized controller 662_{1M}) in an operating system virtualization environment at a given node. In this case, for example, the virtualized entities at node 552_{1M} can access the storage pool 570₁ by interfacing with a controller container (e.g., virtualized controller 662_{1M}) through hypervisor 654_{1M} and/or the kernel of host operating system 656_{1M}.

In certain embodiments, one or more instances of a request debugger can be implemented in the distributed storage system 660 to facilitate the herein disclosed techniques. Specifically, as shown, request debugger 102₁₁ can be implemented in the virtualized controller 662₁₁ and request debugger 102_{1M} can be implemented in the virtualized controller 662_{1M}. As an example, the request debugger can be instantiated as a layer in a web services stack implemented in the virtualized controller. Such instances of the request debugger and/or virtualized controller can be implemented in any node in any cluster. Actions taken by one or more instances of the request debugger and/or virtualized controller can apply to a node (or between nodes), and/or to a cluster (or between clusters), and/or between any resources or subsystems or processing environments accessible by the virtualized controller or their agents (e.g., request debugger). As further shown, any of the foregoing virtualized entities can host instances of the earlier described remote debug server and/or other components and/or agents. For example, remote debug server 140 might run on the virtual machine identified as VE 658_{1M1}.

As earlier indicated, the web services may be instantiated within a web services stack implemented in a virtualized controller. Moreover the web services may pertain to any operational and/or performance characteristics of the cluster. Strictly as examples, such web services might comprise access to virtual machine information, and/or access to storage pool information (e.g., IO rates, pending IO queues, networked storage statistics, etc.), and/or containerized virtualized controller statistics, and/or then current operational and/or performance characteristics of the virtualized controller, its hosting node and/or the hosting cluster.

The datastores associated with the herein disclosed techniques can be stored in various storage facilities in the storage pool 570₁. As an example, various instances of the debug rules 108 and log files 440 might be distributed across the storage pool 570₁ to facilitate reliable access by various instances of the earlier described client application, the request debugger, the remote debug server, and/or the virtualized controller. The web services (e.g., web service 130_{1K1}, web service 130_{1M1}, etc.) accessed according to the herein disclosed techniques can operate on any of the nodes in a given cluster and/or on resources distributed across multiple clusters, and/or via accessing remote web services that are serviced from outside of the clusters.

### Additional Embodiments of the Disclosure

### Additional Practical Application Examples

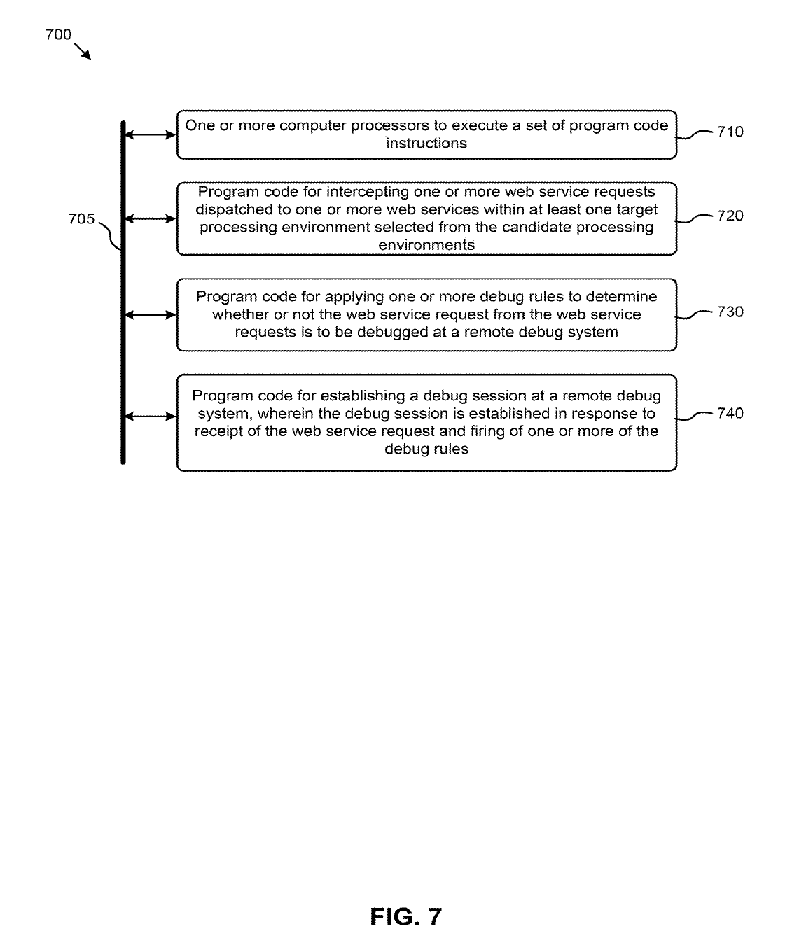

FIG. 7 depicts a system 700 as an arrangement of computing modules that are interconnected so as to operate cooperatively to implement certain of the herein-disclosed embodiments. This and other embodiments present particular arrangements of elements that, individually and/or as combined, serve to form improved technological processes that address the technical problems attendant to efficiently debugging web service requests even when web service requests are dynamically dispatched to processing environments that are not known by the web service requestor. The partitioning of system 700 is merely illustrative and other partitions are possible. As an option, the system 700 may be implemented in the context of the architecture and functionality of the embodiments described herein. Of course, however, the system 700 or any operation therein may be carried out in any desired environment.

The system 700 comprises at least one processor and at least one memory, the memory serving to store program instructions corresponding to the operations of the system. As shown, an operation can be implemented in whole or in part using program instructions accessible by a module. The modules are connected to a communication path 705, and any operation can communicate with other operations over communication path 705. The modules of the system can, individually or in combination, perform method operations within system 700. Any operations performed within system 700 may be performed in any order unless as may be specified in the claims.

The shown embodiment implements a portion of a computer system, presented as system 700, comprising a computer processor to execute a set of program code instructions (module 710) and modules for accessing memory to hold program code instructions to perform: intercepting one or more web service requests dispatched to one or more web services within at least one target processing environment selected from the candidate processing environments (module 720); applying one or more debug rules to determine whether or not the web service request from the web service requests is to be debugged at a remote debug system (module 730); and establishing a debug session at a remote debug system, wherein the debug session is established in response to receipt of the web service request and firing of one or more of the debug rules (module 740).

Variations of the foregoing may include more or fewer of the shown modules. Certain variations may perform more or fewer (or different) steps, and/or certain variations may use data elements in more, or in fewer (or different) operations.

### System Architecture Overview

### Additional System Architecture Examples

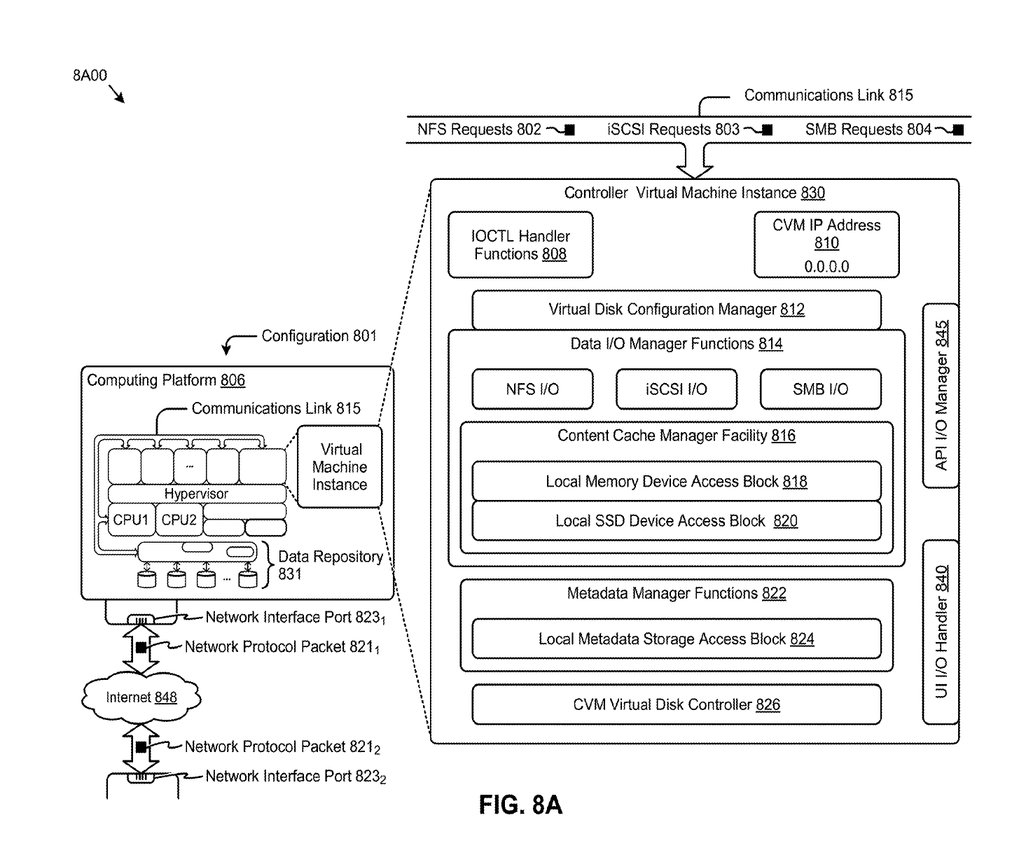

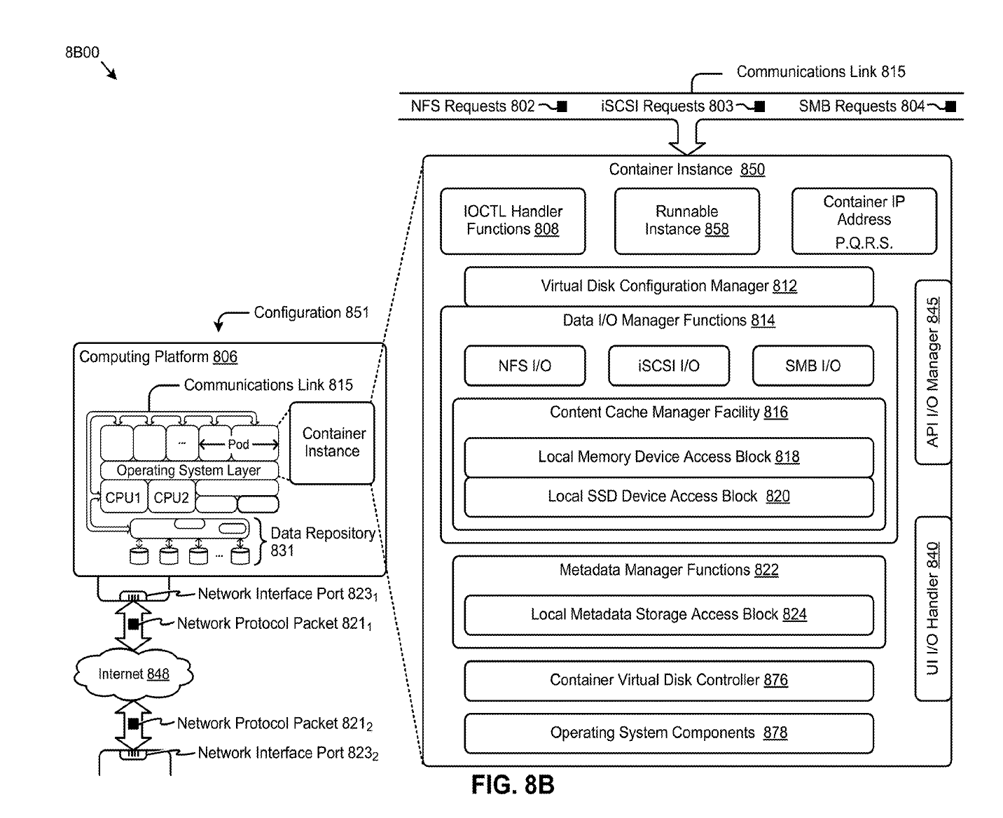

FIG. 8A depicts a virtualized controller as implemented by the shown virtual machine architecture 8A00. The heretofore-disclosed embodiments including variations of any virtualized controllers can be implemented in distributed systems where a plurality of networked-connected devices communicate and coordinate actions using inter-component messaging. Distributed systems are systems of interconnected components that are designed for or dedicated to storage operations as well as being designed for, or dedicated to, computing and/or networking operations. Interconnected components in a distributed system can operate cooperatively so as to serve a particular objective, such as to provide high-performance computing, high-performance networking capabilities, and/or high performance storage and/or high capacity storage capabilities. For example, a first set of components of a distributed computing system can coordinate to efficiently use a set of computational or compute resources, while a second set of components of the same distributed storage system can coordinate to efficiently use a set of data storage facilities.

A hyperconverged system coordinates efficient use of compute and storage resources by and between the components of the distributed system. Adding a hyperconverged unit to a hyperconverged system expands the system in multiple dimensions. As an example, adding a hyperconverged unit to a hyperconverged system can expand in the dimension of storage capacity while concurrently expanding in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as containers. In some systems and/or environments, hypervisor-assisted virtualization techniques and operating system virtualization techniques are combined.

As shown, the virtual machine architecture 8A00 comprises a collection of interconnected components suitable for implementing embodiments of the present disclosure and/or for use in the herein-described environments. Moreover, the shown virtual machine architecture 8A00 includes a virtual machine instance in a configuration 801 that is further described as pertaining to the controller virtual machine instance 830. A controller virtual machine instance receives block I/O (input/output or 10) storage requests as network file system (NFS) requests in the form of NFS requests 802, and/or internet small computer storage interface (iSCSI) block IO requests in the form of iSCSI requests 803, and/or Samba file system (SMB) requests in the form of SMB requests 804. The controller virtual machine (CVM) instance publishes and responds to an internet protocol (IP) address (e.g., CVM IP address 810). Various forms of input and output (I/O or IO) can be handled by one or more IO control handler functions (e.g., IOCTL functions 808) that interface to other functions such as data IO manager functions 814 and/or metadata manager functions 822. As shown, the data IO manager functions can include communication with a virtual disk configuration manager 812 and/or can include direct or indirect communication with any of various block IO functions (e.g., NFS IO, iSCSI IO, SMB IO, etc.).

In addition to block IO functions, the configuration 801 supports IO of any form (e.g., block IO, streaming IO, packet-based IO, HTTP traffic, etc.) through either or both of a user interface (UI) handler such as UI IO handler 840 and/or through any of a range of application programming interfaces (APIs), possibly through the shown API IO manager 845.

The communications link 815 can be configured to transmit (e.g., send, receive, signal, etc.) any types of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of or in combination with software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as disk drives or tape drives. Volatile media includes dynamic memory such as a random access memory. As shown, the controller virtual machine instance 830 includes a content cache manager facility 816 that accesses storage locations, possibly including local dynamic random access memory (DRAM) (e.g., through the local memory device access block 818) and/or possibly including accesses to local solid state storage (e.g., through local SSD device access block 820).

Common forms of computer readable media include any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of external data repository 831, which in turn can be formatted into any one or more storage areas, and which can comprise parameterized storage accessible by a key (e.g., a filename, a table name, a block address, an offset address, etc.). An external data repository 831 can store any forms of data, and may comprise a storage area dedicated to storage of metadata pertaining to the stored forms of data. In some cases, metadata, can be divided into portions. Such portions and/or cache copies can be stored in the external storage data repository and/or in a local storage area (e.g., in local DRAM areas and/or in local SSD areas). Such local storage can be accessed using functions provided by a local metadata storage access block 824. The external data repository 831 can be configured using a CVM virtual disk controller 826, which can in turn manage any number or any configuration of virtual disks.

Execution of the sequences of instructions to practice certain embodiments of the disclosure are performed by one or more instances of a software instruction processor, or a processing element such as a data processor, or such as a central processing unit (e.g., CPU1, CPU2). According to certain embodiments of the disclosure, two or more instances of a configuration 801 can be coupled by a communications link 815 (e.g., backplane, LAN, PSTN, wired or wireless network, etc.) and each instance may perform respective portions of sequences of instructions as may be required to practice embodiments of the disclosure.

The shown computing platform 806 is interconnected to the Internet 848 through one or more network interface ports (e.g., network interface port 823₁ and network interface port 823₂). The configuration 801 can be addressed through one or more network interface ports using an IP address. Any operational element within computing platform 806 can perform sending and receiving operations using any of a range of network protocols, possibly including network protocols that send and receive packets (e.g., network protocol packet 821₁ and network protocol packet 821₂).

The computing platform 806 may transmit and receive messages that can be composed of configuration data, and/or any other forms of data and/or instructions organized into a data structure (e.g., communications packets). In some cases, the data structure includes program code instructions (e.g., application code) communicated through the Internet 848 and/or through any one or more instances of communications link 815. Received program code may be processed and/or executed by a CPU as it is received and/or program code may be stored in any volatile or non-volatile storage for later execution. Program code can be transmitted via an upload (e.g., an upload from an access device over the Internet 848 to computing platform 806). Further, program code and/or results of executing program code can be delivered to a particular user via a download (e.g., a download from the computing platform 806 over the Internet 848 to an access device).

The configuration 801 is merely one sample configuration. Other configurations or partitions can include further data processors, and/or multiple communications interfaces, and/or multiple storage devices, etc. within a partition. For example, a partition can bound a multi-core processor (e.g., possibly including embedded or co-located memory), or a partition can bound a computing cluster having plurality of computing elements, any of which computing elements are connected directly or indirectly to a communications link. A first partition can be configured to communicate to a second partition. A particular first partition and particular second partition can be congruent (e.g., in a processing element array) or can be different (e.g., comprising disjoint sets of components).

A cluster is often embodied as a collection of computing nodes that can communicate between each other through a local area network (e.g., LAN or VLAN) or a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provision of power to the other units. In some cases, a unit in a rack is dedicated to environmental conditioning functions such as filtering and movement of air through the rack, and/or temperature control for the rack. Racks can be combined to form larger clusters. For example, the LAN of a first rack having 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or LAN (e.g., when geographically proximal).

A module as used herein can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to implement algorithms that facilitate operational and/or performance characteristics pertaining to techniques for efficiently debugging dynamically distributed web service requests in distributed computing environments. In some embodiments, a module may include one or more state machines and/or combinational logic used to implement or facilitate the operational and/or performance characteristics pertaining to techniques for efficiently debugging dynamically distributed web service requests in distributed computing environments.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of technological solutions for efficiently debugging dynamically distributed web service requests in distributed computing environments). Such files or records can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to efficiently debugging dynamically distributed web service requests in distributed computing environments, and/or for improving the way data is manipulated when performing computerized operations pertaining to dynamically invoking a debug session at a predetermined computing environment to debug a web service request regardless of the target processing environment for the request selected by a web service request dispatcher.

Further details regarding general approaches to managing data repositories are described in U.S. Pat. No. 8,601,473 titled, “ARCHITECTURE FOR MANAGING I/O AND STORAGE FOR A VIRTUALIZATION ENVIRONMENT” issued on Dec. 3, 2013, which is hereby incorporated by reference in its entirety.

Further details regarding general approaches to managing and maintaining data in data repositories are described in U.S. Pat. No. 8,549,518 titled, “METHOD AND SYSTEM FOR IMPLEMENTING MAINTENANCE SERVICE FOR MANAGING I/O AND STORAGE FOR A VIRTUALIZATION ENVIRONMENT” issued on Oct. 1, 2013, which is hereby incorporated by reference in its entirety.

FIG. 8B depicts a virtualized controller implemented by a containerized architecture 8B00. The containerized architecture comprises a collection of interconnected components suitable for implementing embodiments of the present disclosure and/or for use in the herein-described environments. Moreover, the shown containerized architecture 8B00 includes a container instance in a configuration 851 that is further described as pertaining to the container instance 850. The configuration 851 includes an operating system layer (as shown) that performs addressing functions such as providing access to external requestors via an IP address (e.g., “P.Q.R.S”, as shown). Providing access to external requestors can include implementing all or portions of a protocol specification (e.g., “http:”) and possibly handling port-specific functions.

The operating system layer can perform port forwarding to any container (e.g., container instance 850). A container instance can be executed by a processor. Runnable portions of a container instance sometimes derive from a container image, which in turn might include all, or portions of any of, a Java archive repository (JAR) and/or its contents, and/or a script or scripts and/or a directory of scripts, and/or a virtual machine configuration, and may include any dependencies therefrom. In some cases a configuration within a container might include an image comprising a minimum set of runnable code. Contents of larger libraries and/or code or data that would not be accessed during runtime of the container instance can be omitted from the larger library to form a smaller library composed of only the code or data that would be accessed during runtime of the container instance. In some cases, start-up time for a container instance can be much faster than start-up time for a virtual machine instance, at least inasmuch as the container image might be much smaller than a respective virtual machine instance. Furthermore, start-up time for a container instance can be much faster than start-up time for a virtual machine instance, at least inasmuch as the container image might have many fewer code and/or data initialization steps to perform than a respective virtual machine instance.

A container instance (e.g., a Docker container) can serve as an instance of an application container. Any container of any sort can be rooted in a directory system, and can be configured to be accessed by file system commands (e.g., “ls” or “ls-a”, etc.). The container might optionally include operating system components 878, however such a separate set of operating system components need not be provided. As an alternative, a container can include a runnable instance 858, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, a container virtual disk controller 876. Such a container virtual disk controller can perform any of the functions that the aforementioned CVM virtual disk controller 826 can perform, yet such a container virtual disk controller does not rely on a hypervisor or any particular operating system so as to perform its range of functions.

In some environments multiple containers can be collocated and/or can share one or more contexts. For example, multiple containers that share access to a virtual disk can be assembled into a pod (e.g., a Kubernetes pod). Pods provide sharing mechanisms (e.g., when multiple containers are amalgamated into the scope of a pod) as well as isolation mechanisms (e.g., such that the namespace scope of one pod does not share the namespace scope of another pod).

In the foregoing specification, the disclosure has been described with reference to specific embodiments thereof. It will however be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A method for debugging a web service request that is dispatched to one of a set of candidate processing environments in a computing system, the method comprising:
detecting one or more web service requests dispatched to one or more web services within at least one target processing environment selected from the candidate processing environments;
applying one or more debug rules to identify the web service request from the web service requests; and
establishing a debug session at a remote debug system, wherein the debug session is established in response to receipt of the web service request.

2. The method of claim 1, further comprising capturing a set of debug information at the remote debug system, wherein the debug information is derived from one or more web service transaction messages associated with processing the web service request.

3. The method of claim 2, further comprising receiving at least a portion of the debug information from a web server in the target processing environment.

4. The method of claim 3, further comprising transmitting at least a portion of the debug information from the web server to a console of the remote debug system.

5. The method of claim 2, further comprising presenting at least a portion of the debug information in a user interface.

6. The method of claim 1, further comprising closing the debug session in response to completion of the web service request.

7. The method of claim 1, wherein at least one of the debug rules is specified by a user at a user interface.

8. The method of claim 1, wherein the remote debug system is implemented in a predetermined computing environment.

9. The method of claim 1, wherein at least one of, detecting the web service requests, applying the debug rules, or establishing the debug session, is performed by a layer in a web services stack in the target processing environment.

10. The method of claim 9, wherein the layer is between a service request handler and a web server in the web services stack.

11. A computer readable medium, embodied in a non-transitory computer readable medium, the non-transitory computer readable medium having stored thereon a sequence of instructions which, when stored in memory and executed by one or more processors causes the one or more processors to perform a set of acts for debugging a web service request that is dispatched to one of a set of candidate processing environments in a computing system, the acts comprising:
detecting one or more web service requests dispatched to one or more web services within at least one target processing environment selected from the candidate processing environments;
applying one or more debug rules to identify the web service request from the web service requests; and
establishing a debug session at a remote debug system, wherein the debug session is established in response to receipt of the web service request.

12. The computer readable medium of claim 11, further comprising instructions which, when stored in memory and executed by the one or more processors causes the one or more processors to perform acts of capturing a set of debug information at the remote debug system, wherein the debug information is derived from one or more web service transaction messages associated with processing the web service request.

13. The computer readable medium of claim 12, further comprising instructions which, when stored in memory and executed by the one or more processors causes the one or more processors to perform acts of receiving at least a portion of the debug information from a web server in the target processing environment.

14. The computer readable medium of claim 13, further comprising instructions which, when stored in memory and executed by the one or more processors causes the one or more processors to perform acts of transmitting at least a portion of the debug information from the web server to the remote debug system.

15. The computer readable medium of claim 12, further comprising instructions which, when stored in memory and executed by the one or more processors causes the one or more processors to perform acts of presenting at least a portion of the debug information in a user interface.

16. The computer readable medium of claim 11, further comprising instructions which, when stored in memory and executed by the one or more processors causes the one or more processors to perform acts of closing the debug session in response to completion of the web service request.

17. The computer readable medium of claim 11, wherein at least one of the debug rules is specified by a user at a user interface.

18. The computer readable medium of claim 11, wherein the remote debug system is implemented in a predetermined computing environment.

19. A system for debugging a web service request that is dispatched to one of a set of candidate processing environments in a computing system, the system comprising:
a storage medium having stored thereon a sequence of instructions; and
one or more processors that execute the instructions to cause the one or more processors to perform a set of acts, the acts comprising,
detecting one or more web service requests dispatched to one or more web services within at least one target processing environment selected from the candidate processing environments;
applying one or more debug rules to identify the web service request from the web service requests; and
establishing a debug session at a remote debug system, wherein the debug session is established in response to receipt of the web service request.

20. The system of claim 19, wherein the remote debug system is a laptop computer.
